(19) United States
(12) Patent Application Publication
(10) Pub. No.: US 2010/0153308 A1
(43) Pub. Date: Jun. 17, 2010

(54) Method and Device for Ascertaining Minimum Costs from a Starting Location to a Destination for the Purpose of Planning a Route

(75) Inventors: Martin Pfeifle, Maxhuette-Haidhof (DE); Volker Sasse, Lappersdorf (DE); Uwe Tantz, Nittendorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/226,643

(22) PCT Filed: Apr. 18, 2007
(86) PCT No.: PCT/EP2007/053776

§ 371 Date: Nov. 20, 2008

(30) Foreign Application Priority Data
Apr. 24, 2006 (DE) 10 2006 018 879.9

(51) Int. Cl. G06F 17/00

(52) U.S. Cl. 705/400

(57) ABSTRACT

The aim of the invention is to determine the minimum costs (MIN KOST) from a starting location (STO) to a destination (ZIO), in order to plan a route from said starting location (STO) to the destination (ZIO). To achieve this, a starting node (STK) is determined in accordance with the starting location (STO). Corresponding starting node costs (STK_KOST) to starting map markers (LM_ST) are determined in accordance with the starting nodes (STK). A destination node (ZIK) is determined in accordance with the destination (ZIO). The destination node costs (ZIK_KOST) to destination map markers (LM_ZI) are determined in accordance with the destination nodes (ZIK). In addition, map marker costs (LM_KOST) from each starting map marker (LM_ST) to each destination map marker (LM_ZI) are determined with the aid of a table, which comprises the map marker costs (LM_KOST) of all map markers to all other map markers. The minimum costs (MIN_KOST) are determined in accordance with the previously determined starting node costs (STK_KOST), destination node costs (ZIK_KOST) and map marker costs (LM_KOST).

Method and device for ascertaining minimum costs from a starting location to a destination for the purpose of planning a route

The invention relates to a method and a device for ascertaining minimum costs from a starting location to a destination for the purpose of planning a route from the starting location to the destination. The starting location is taken as a basis for ascertaining a starting node, and the destination is taken as a basis for ascertaining a destination node.

US 2002/0059025 A1 discloses a method for finding a shortest path from a starting location to a destination in a traffic network. This involves the use of a Dijkstra algorithm and a Floyd-Warshal algorithm.

EP 504 854 A1 discloses a method for selecting a route. The route is obtained by looking for a first route from a starting point to a first route memory point which is stored in an intermediate point memory. A second route from a destination to a second route memory point which is stored in the intermediate point memory is then sought. A third route is ascertained between the first route memory point and the second route memory point. The first, the second and the third routes are then connected to form an overall route.

EP 372 840 A2 discloses an adaptive routing system for a vehicle. The navigation system comprises a map memory unit, a position finding unit and a route calculation unit. The map memory unit stores buildings and road data which comprise nodes and connections. The route calculation unit reads the road data which comprise the current position and a destination.

It is an object of the invention to provide a method and an apparatus which simply allow effective route planning.

The object is achieved by the features of the independent claims. Advantageous refinements of the invention are characterized in the subclaims.

The invention is characterized by a method and a device for ascertaining minimum costs between a starting location and a destination using a prescribed map which is divided into prescribed map details. The minimum costs are ascertained for the purpose of planning a route from the starting location to the destination. The starting location is taken as a basis for ascertaining a starting node. The starting node represents a gateway from one of the prescribed map details from the map to another of the prescribed map details from the map. The starting node has starting node costs to at least one prescribed starting map marker from a prescribed set of starting map markers associated with it. The set of starting map markers comprises a prescribed first number of map markers which are closest to the starting node. The prescribed first number is smaller than the total number of all the map markers. The starting node is taken as a basis for ascertaining the corresponding starting node costs for each starting map marker. The destination is taken as a basis for ascertaining a destination node. The destination node represents a gateway from one of the prescribed map details from the map to another of the prescribed map details from the map. The destination node has at least destination node costs from the destination node to at least one prescribed destination map marker from a prescribed set of destination map markers associated with it. The set of destination map markers comprises a prescribed second number of map markers which are closest to the destination node. The prescribed second number is smaller than the total number of all the map markers. The destination node is taken as a basis for ascertaining the corresponding destination node costs to each destination map marker. Map marker costs from each starting map marker to each destination map marker are ascertained using a table which comprises the map marker costs for all the map markers relative to one another. The minimum costs are ascertained on the basis of the ascertained starting node costs, the ascertained destination node costs and the ascertained map marker costs.

In comparison with a method in which each node has the costs to all the map markers associated with it, this allows the required volume of data for ascertaining the minimum costs to be greatly reduced and hence so much memory space to be saved that the method can be carried out exclusively on a mobile appliance for planning the route. Ascertaining the minimum costs allows the search area in the search for the route to be greatly restricted, and is therefore conducive to rapid ascertainment of the route. Particularly a first direction output from the mobile appliance for planning the route following an input by a user of the appliance can be output very quickly. If the map details are stored on a storage medium in an appliance for ascertaining the route in respective cohesive memory areas, then the association of the node costs with the nodes which represent the gateways allows only two map details for a respective starting location and a respective destination to require loading for the purpose of planning the route. This is conducive to very rapid ascertainment of the minimum costs.

In one advantageous refinement of the method, the minimum costs are ascertained using the prescribed map. The prescribed map is divided into the prescribed map details. One of the map details which comprises a distinguished starting location and/or destination has at least one piece of supplementary information prescribed for it in comparison with one of the map details which does not comprise a distinguished starting location and/or destination. This can be conducive, in cases in which the starting location and/or the destination correspond to the distinguished starting locations or destinations, to particularly rapid planning of the route.

In another advantageous refinement of the method, at least one additional map marker is prescribed as the piece of supplementary information. This may be conducive to particularly rapid planning of the route.

In another advantageous refinement of the method, as the piece of supplementary information, one of the map markers is prescribed such that it corresponds to the distinguished starting location and/or destination. This may be conducive to particularly rapid planning of the route if the starting location and/or the destination correspond to the distinguished starting locations or destinations.

[symbol]

the map markers which are closest to the starting node. The prescribed first number is smaller than the total number of all map markers. The starting node is taken as a basis for ascertaining the corresponding starting node costs to each starting map marker.

The destination is taken as a basis for ascertaining a destination node. The destination node has at least destination node costs from the destination node to at least one prescribed destination map marker from a prescribed set of destination map markers associated with it. The set of destination map markers comprises a prescribed second number of the map markers which are closest to the destination node. The prescribed second number is smaller than the total number of all map markers. The destination node is taken as a basis for ascertaining the corresponding destination node costs to each destination map marker. Map marker costs from each starting map marker to each destination map marker are ascertained using a table which comprises the map marker costs for all map markers. The minimum costs are ascertained on the basis of the ascertained starting node costs, the ascertained destination node costs and the ascertained map marker costs.

In comparison with a method in which each node has the costs to all the map markers associated with it, this allows the required volume of data for ascertaining the minimum costs to be greatly reduced and hence so much memory space to be saved that the method can be carried out exclusively on a mobile appliance for planning the route. Ascertaining the minimum costs allows the search area in the search for the route to be greatly restricted, and is therefore conducive to rapid ascertainment of the route. Particularly a first direction output from the mobile appliance for planning the route following an input by a user of the appliance can be output very quickly.

In one advantageous refinement of the method, the minimum costs are ascertained using a prescribed map. The prescribed map is divided into prescribed map details. The node costs from the nodes to the closest map markers are associated only with the nodes which represent gateways from one of the prescribed map details from a map to another of the prescribed map details from the map. If the map details are stored on a storage medium in an appliance for ascertaining the route in respective cohesive memory areas, this allows just two map details for a respective starting location and a respective destination to require loading for the purpose of planning the route. This is conducive to very rapid ascertainment of the minimum costs.

In another advantageous refinement of the method, the minimum costs are ascertained using the prescribed map. The prescribed map is divided into the prescribed map details. One of the map details which comprises a distinguished starting location and/or destination has at least one piece of supplementary information prescribed for it in comparison with one of the map details which does not comprise a distinguished starting location or destination. This may be conducive to particularly rapid planning of the route in cases in which the starting location and/or the destination correspond to the distinguished starting locations or destinations.

In another advantageous refinement of the method, at least one additional map marker is prescribed as the piece of supplementary information. This may be conducive to particularly rapid planning of the route.

In another advantageous refinement of the method, as the piece of supplementary information, one of the map markers is prescribed such that it corresponds to the distinguished starting location and/or destination. This may be conducive to particularly rapid planning of the route if the starting location and/or the destination correspond to the distinguished starting locations or destinations.

In another advantageous refinement of the method, spatial and/or temporal costs from nodes to the map markers and/or from the map markers to one another are prescribed. The spatial costs represent physical distances between the nodes and the map markers or between the map markers themselves. The temporal costs represent an average journey time from one of the nodes to another of the nodes or from one of the map markers to another of the map markers. This allows dynamic traffic conditions, such as tailbacks, road works and/or commuter traffic, and/or speed restrictions and/or toll charges to be taken into account when planning the route.

In a further advantageous embodiment of the method, the temporal and/or spatial costs are weighted on the basis of the user requirement. The route and/or the minimum costs are ascertained on the basis of the weighted costs. This allows the user himself to decide from route to route how important speed, time and/or route length are to him when planning the route.

The advantageous refinements of the method can readily be transferred to advantageous refinements of the apparatus.

The invention is explained in more detail below with reference to schematic drawings, in which:

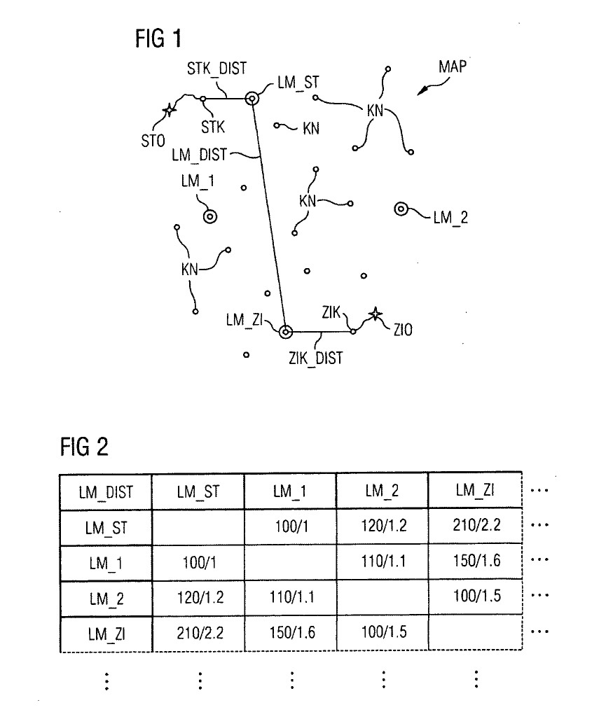

FIG. 1 shows a first view of a map,

FIG. 2 shows a table with map marker costs,

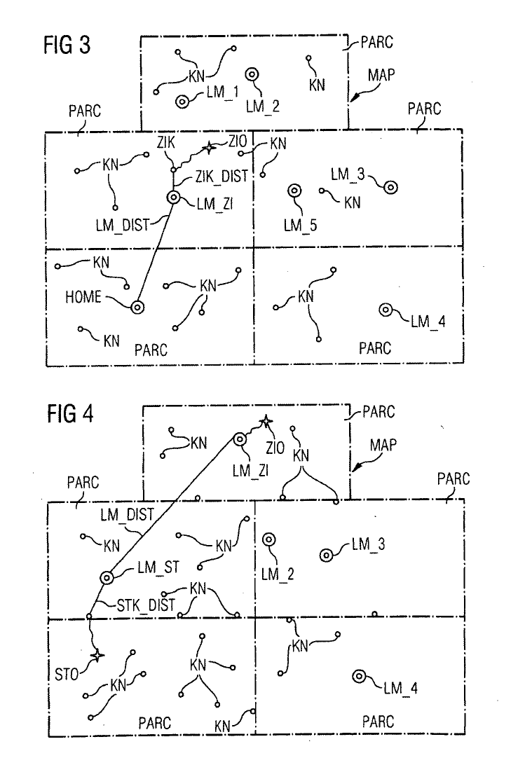

FIG. 3 shows a second view of the map with map details

FIG. 4 shows a third view of the map with further map details,

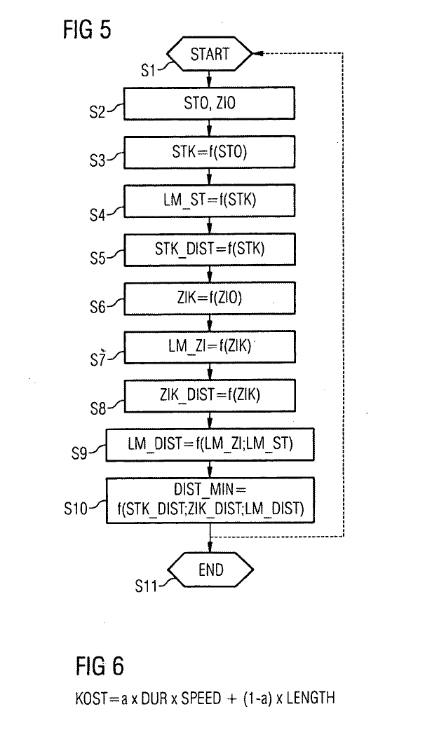

FIG. 5 shows a flowchart for ascertaining minimum costs,

FIG. 6 shows a computation code for weighting costs.

Elements of the same design or function are identified by the same reference symbols across the figures.

A map MAP (FIG. 1) comprises nodes KN, map markers and at least one starting location STO and at least one destination ZIO. Each of the nodes KN is preferably representative of a road junction. The map markers comprise at least one destination map marker LM_ZI and at least one starting map marker LM_ST, first to fifth map markers LM_1-LM_5 (see FIG. 3) and preferably at least one distinguished map marker HOME (see FIG. 3). The nodes KN comprise at least one starting node STK and a destination node ZIK. The starting node STK represents the closest node KN to the starting location STO. The starting node STK has starting node costs STK_KOST to the starting map marker LM_ST. The destination node ZIK represents the closest node KN to the destination ZIO. The destination node ZIK has destination node costs ZIK_KOST to the destination map marker LM_ZI. The starting map marker LM_ST and the destination map marker LM_ZI have map marker costs LM_KOST relative to one another.

The costs comprise node costs and the map marker costs LM_KOST. The node costs comprise the starting node costs STK_KOST, the destination node costs ZI_KOST and further node costs from one of the nodes KN to another of the nodes KN. By way of example, the costs are representative of physical distances between the nodes and the map markers, of physical distances between the map markers themselves, of journey times DUR required on average in order to cover the physical distances, of speed restrictions and/or of toll booths.

Each node KN has the node costs to a prescribed number of closest map markers associated with it. In this connection, by way of example, associated may mean that a storage medium on which the map MAP is stored respectively stores one of the nodes KN and the corresponding node costs in a cohesive memory area. This is particularly advantageous, since when the node KN is loaded for the purpose of ascertaining a route and/or minimum costs MIN_KOST which are required for the route, the corresponding node costs are then also automatically loaded. This means that no additional time is required in order to ascertain the node costs. The prescribed number of map markers is preferably far smaller than the total number of all the map markers. By way of example, the number of closest map markers may correspond to one percent of all the map markers. The number of closest map markers may vary from node KN to node KN, but it may also be firmly prescribed for all the nodes KN.

The map marker costs LM_KOST for all the map markers relative to one another are preferably stored in a table (FIG. 2). The table is preferably stored on the storage medium. By way of example, the costs between the starting map marker LM_ST and the first map marker LM_1 for a vehicle are on average one hundred kilometers and one hour. That is to say that a vehicle covers the one hundred kilometers between the starting map marker LM_ST and the first map marker LM_1 in one hour on average. The table does not have to be symmetrical. In this connection, this means that, by way of example, the starting node costs incurred from the starting node STK to the starting node marker LM_ST are different than from the starting node marker LM_ST to the starting node STK. This can be caused by a one-way street along the route, for example. In addition, all the costs may be dependent on the direction in which the route is traveled.

Preferably, the map MAP is divided into map details PARC (FIG. 3). Preferably, each of the map details PARC is stored as a cohesive data packet, for example as a binary large object (BLOB), in a cohesive memory area of the storage medium.

Preferably, at least one distinguished starting location and/or destination is prescribed. Preferably, the distinguished starting location or destination corresponds to a starting location or destination STO, ZIO which a user of an appliance frequently selects to plan the route. The distinguished starting location or destination is then preferably assigned the distinguished map marker HOME. The map marker costs LM_KOST from the distinguished map marker HOME to the other map markers are then stored in the table of map marker costs LM_KOST. In the case of route planning starting from or arriving at the distinguished map marker HOME, the minimum costs MIN_KOST and/or the route can then be calculated very quickly, since it is not necessary to ascertain a starting node STK or destination node ZIK. In particular, there is as a result no need to ascertain the starting node costs STK_KOST or the destination node costs ZIK_KOST. By way of example, the distinguished map marker HOME may be representative of a place of work of the user, of a place of residence and/or, by way of example, a favorite leisure facility of the user.

Providing the distinguished starting location and/or destination STO, ZIO with the distinguished map marker HOME can

[symbol]

the program was first started, this node KN can preferably be used as the new starting location STO and/or as the new starting node STK for ascertaining new minimum costs MIN_KOST.

In connection with the spatial and temporal costs, it is particularly advantageous if not only either the spatial costs, the temporal costs or the other costs are taken into account in the route planning but rather all of them at the same time. To this end, it is particularly advantageous if the user himself is able to weight how important it is to him to optimize the route in terms of journey time DUR, route length to be covered LENGTH and/or toll charges, for example. By way of example, weighted costs COST (FIG. 6) can be ascertained as a function of the journey time DUR, an average possible speed SPEED of the motor vehicle, the route length LENGTH and a weighting factor a, preferably on the basis of the computation code indicated in FIG. 6. The weighting factor a is preferably a percentage variable. The data stored are respectively only the one hundred percent values at the relevant nodes KN, and the individual weighting is effected on the basis of a user requirement from the user in real time during ascertainment of the route, particularly during ascertainment of the minimum costs MIN_KOST. Hence, almost an infinite number of combinations of different weighting possibilities can be provided, even though only a greatly limited volume of data to be stored is used for this purpose.

The invention is not limited to the exemplary embodiments indicated. By way of example, the different exemplary embodiments can be combined with one another. By way of example, a map detail PARC which comprises the distinguished starting location or destination can be provided, on the edge of the corresponding map detail PARC, with the distinguished map marker HOME and/or with other additional map markers and/or with more nodes KN which comprise the costs to the closest map markers. In addition, a plurality of map details PARC can be provided with the additional information, in particular it is possible for a plurality of distinguished map markers HOME to be set.

1-8. (canceled)

9. A method for ascertaining a minimum cost route from a starting location to a destination using a map that is divided into a plurality of map sections, the method comprising:
determining a starting node based at least in part on the starting location, the starting node representing a gateway from one of the plurality of map sections to another of the plurality of map sections, wherein the starting node has associated with it starting node costs from the starting node to at least one starting map marker from a set of starting map markers;
determining starting node costs for the starting node to each starting map marker of the set of starting map markers;
determining a destination node based at least in part on the destination, the destination node representing a gateway from one of the plurality of map sections to another of the plurality of map sections, wherein the starting node has associated with it destination node costs from the destination node to at least one destination map marker from a set of destination map markers;
determining destination node costs for the destination node to each destination map marker of the set of destination map markers;
determining map marker costs for each the set of starting map markers to each of the set of destination map markers;
determining the minimum costs based on the determined starting node costs, the determined destination node costs, and the determined map marker costs.

10. The method for ascertaining a minimum cost route according to claim 9, wherein one of the map sections comprises at least one piece of supplementary information and at least one of the starting location and the destination, and another of the map sections does not include either of the starting location and the destination.

11. The method for ascertaining a minimum cost route according to claim 10, wherein the at least one piece of supplementary information is at least one additional map marker.

12. The method for ascertaining a minimum cost route according to claim 11, wherein one of the map markers corresponds to one of the starting location and the destination.

13. The method for ascertaining a minimum cost route according to claim 9, wherein the starting node costs, the destination node costs, and the map marker costs are at least one of spatial costs and temporal costs.

14. The method for ascertaining a minimum cost route according to claim 13, wherein the spatial costs represent physical distances between any of the starting location, the destination, the map sections, the map markers, starting nodes, and destination nodes.

15. The method for ascertaining a minimum cost route according to claim 13, wherein the temporal costs represent an average journey time distances between any of the starting location, the destination, the map sections, the map markers, starting nodes, and destination nodes.

16. The method for ascertaining a minimum cost route according to claim 13, wherein the minimum costs are determined based at least in part on weighted costs, the weighted costs being at least one of a weighted temporal cost and a weighted spatial cost.

17. The method for ascertaining a minimum cost route according to claim 16, wherein the weighting is based on a user requirement.

18. The method for ascertaining a minimum cost route according to claim 9, wherein the set of starting map markers comprises a first number of map markers which are closest to the starting node, the first number of map markers is smaller than the total number of all the map markers.

19. The method for ascertaining a minimum cost route according to claim 9, wherein the set of destination map markers comprises a second number of map markers which are closest to the destination node, the second number of map markers is smaller than the total number of all the map markers.

20. The method for ascertaining a minimum cost route according to claim 9, wherein the map marker costs are determined using a table.

21. An apparatus for determining minimum costs for a route from a starting location to a destination using a map, which is divided into map sections, the apparatus comprising:
determining a starting node based at least in part on the starting location, the starting node representing a gateway from one of the plurality of map sections to another of the plurality of map sections, wherein the starting node has associated with it starting node costs from the starting node to at least one starting map marker from a set of starting map markers;
a module for determining starting node costs for the starting node to each starting map marker of the set of starting map markers;
a module for determining a destination node based at least in part on the destination, the destination node representing a gateway from one of the plurality of map sections to another of the plurality of map sections, wherein the starting node has associated with it destination node costs from the destination node to at least one destination map marker from a set of destination map markers;
a module for determining destination node costs for the destination node to each destination map marker of the set of destination map markers;
a module for determining map marker costs for each the set of starting map markers to each of the set of destination map markers;
a module for determining the minimum costs based on the determined starting node costs, the determined destination node costs, and the determined map marker costs.

22. A method for ascertaining a minimum cost route from a starting location to a destination using a map that is divided into a plurality of map sections, the method comprising:
determining a starting node based on the starting location, the starting node being one of a plurality of nodes closest to the starting location;
determining at starting map markers, the starting map markers being a first set of map markers closest to the starting node;
associating starting node costs from the starting node to the starting map markers;
determining the starting node costs based on the starting node and the determined starting map markers;
determining a destination node based at least in part on the destination, the destination node being the node closest to the destination;
determining destination map markers, the destination map markers being a first set of map markers closest to the destination node;
determining the destination node costs based on the destination node and the determined destination map markers;
determining map marker costs for the determined starting map markers and the determined destination map markers;
determining the minimum costs based at least in part on the determined starting node costs, the determined destination node costs, and the determined map marker costs.

23. The method for ascertaining a minimum cost route according to claim 22, the method further comprising:
calculating differences between the starting node costs and the corresponding starting map marker costs; and
calculating differences between the destination node costs and the corresponding destination map marker costs,
wherein the greatest difference in costs represents the minimum costs.

24. The method for ascertaining a minimum cost route according to claim 22, the method further comprising receiving a user input, the user input designating at least one of the starting location, the destination.

25. The method for ascertaining a minimum cost route according to claim 24, the method further comprising receiving a user input, the user input designating an intermediate node on the route.

26. The method for ascertaining a minimum cost route according to claim 22, wherein the map marker costs are stored in a table.

27. The method for ascertaining a minimum cost route according to claim 22, wherein at least one of the starting nodes, the starting map markers, the destination map markers, the destination nodes, and the destination is used as a revised starting location.
